(19) United States
(12) Patent Application Publication
(10) Pub. No.: US 2004/0257031 A1
(43) Pub. Date: Dec. 23, 2004

(54) Apparatus for detecting fuel cell voltage

(76) Inventor: Dong Woo Kang, Seoul (KR)

Correspondence Address: MORGAN, LEWIS & BOCKIUS, LLP., 2 PALO ALTO SQUARE, 3000 EL CAMINO REAL, PALO ALTO, CA, 94306, US

(21) Appl. No.: 10/670,893

(22) Filed: Sep. 24, 2003

(30) Foreign Application Priority Data
Jun. 9, 2003 (KR) 10-2003-0036870

(51) Int. Cl. H02J 7/00

(52) U.S. Cl. 320/101

(57) ABSTRACT

An apparatus for detecting cell voltage of a fuel cell according to this invention, which is interposed between an SVM (Stack Voltage Monitor) and a cell, consists of a plurality of cell voltage detecting units, and a supporting unit for securing the plurality of cell voltage detecting units to the cells. The cell voltage detecting unit includes a probe having contact with the cell, a spring connected to the probe for absorbing impact, a resistor connected to the spring, and an extend cable interconnecting the resistor and the SVM.

### CROSS-REFERENCE TO RELATED APPLICATIONS

This application claims priority of Korean Application No. 10-2003-0036870, filed on Jun. 9, 2003, the disclosure of which is incorporated fully herein by reference.

### FIELD OF THE INVENTION

Generally, the present invention relates to an apparatus for detecting cell voltage of a fuel cell mounted in a vehicle. More particularly, the present invention relates to an apparatus for detecting cell voltage of a fuel cell, which is interposed between an SVM (Stack Voltage Monitor) and a cell.

### BACKGROUND OF THE INVENTION

In a fuel cell vehicle, a fuel cell stack consists of a plurality of cells. When the fuel cell stack is operated, it is required to measure the cell voltage while preventing short circuits.

Conventionally, if it is required to measure the cell voltage, a probe connected to an extend cable is welded into each cell. The extend cable from the probe is attached to a supporting unit.

However, in the case where the probe connected to the extend cable is welded into the cell, it is difficult to maintain contact between the probe and the cell when an impact is applied to the vehicle or the cell stack. Furthermore, a plurality of probes and extend cables are located in a predetermined limited space such that the possibility of a short circuit is increased and an MEA (Membrane Electrode Assembly) of the cell can be damaged.

The information disclosed in this Background of the Invention section is only for enhancement of understanding of the background of the invention and should not be taken as an acknowledgement or any form of suggestion that this information forms the prior art that is already known to a person skilled in the art.

### SUMMARY OF THE INVENTION

An exemplary cell voltage detecting unit interconnecting a cell and an SVM according to an embodiment of the present invention comprises a probe having contact with the cell, a elastic means connected to the probe for absorbing impact, a resistor connected to the elastic means, and an extend cable interconnecting the resistor and the SVM. Preferably, the elastic means is a spring.

In a further embodiment, the cell voltage detecting unit further comprises a spring housing formed around the spring. Preferably, the housing is formed of epoxy resin.

An exemplary cell voltage detecting assembly interconnecting a cell and the SVM according to an embodiment of the present invention comprises a plurality of cell voltage detecting units, and a supporting unit for securing the cell voltage detecting units to the cells.

In a further embodiment, a plurality of probe holes are formed through the supporting unit for respectively receiving the housings formed around the elastic means, and a plurality of guide holes are formed on a side wall of the supporting unit for guiding the extend cables to the SVM. Preferably, the elastic means is a spring.

In another further embodiment, the surface of the supporting unit opposite to the cells is covered with silicon resin for insulation.

In yet another further embodiment, the cell voltage detecting assembly further comprises a cover plate for covering the supporting unit.

### BRIEF DESCRIPTION OF THE DRAWINGS

The accompanying drawings, which are incorporated in and constitute a part of the specification, illustrate an embodiment of the invention, and, together with the description, serve to explain the principles of the invention:

FIG. 1 is a schematic view of a cell voltage detecting unit according to a preferred embodiment of the present invention;

FIG. 2 is a plan view of a cell voltage detecting assembly according to a preferred embodiment of the present invention;

FIG. 3 is a sectional view taken on line a-a′ of the FIG. 2;

FIG. 4 is a sectional view taken on line a-a′ of the FIG. 2 provided with a cover plate.

### DETAILED DESCRIPTION OF THE PREFERRED EMBODIMENTS

A preferred embodiment of the present invention will hereinafter be described in detail with reference to the accompanying drawings.

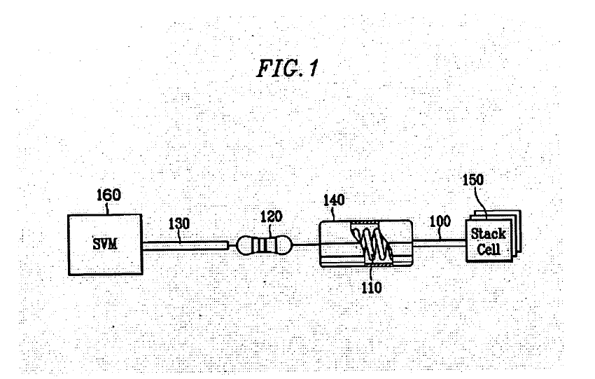

As shown in FIG. 1, a cell voltage detecting unit interconnects a SVM (Stack Voltage Monitor) 160 and a cell 150. A plurality of cells 150 is stacked such that a cell stack is formed. The SVM 160 computes and displays the cell voltage based on electric signals from the cell through the cell voltage detecting unit. The cell voltage detecting unit includes a probe 100, a spring 110, a resistor 120, an extend cable 130, and a spring housing 140. The probe 100 is formed of a conductor and is electrically connected to the cell 150 for detecting the cell voltage.

The spring 110 is connected to the probe 100 such that an impact, which is transferred to the cell 150, can be absorbed. Accordingly, separation of the probe from the cell 150 is prevented. The spring is formed of a conductor, preferably the same material as the probe 100, or it can be integrated with the probe 100.

The resistor 120 is connected to the spring 110. Accordingly, in the case that a plurality of cell voltage detecting units is connected to the cell stack in a limited space, the resistor 120 protects from a short circuit such that damage of the MEA (Membrane Electrode Assembly) provided to the cell 150 can be prevented.

An extend cable 130 is connected the resistor 120 and is extended to the SVM 160 such that the SVM 160 computes the cell voltage based on transferred electric signals from the cell. Preferably, the extend cable 130 is insulated with “Teflon” having heat resistance within a predetermined temperature range such that detecting the cell voltage can be performed under conditions within the predetermined temperature range.

A spring housing 140 is formed around the spring 110 such that the spring 110 is insulated and secured. Preferably, the spring housing 140 is formed of epoxy resin.

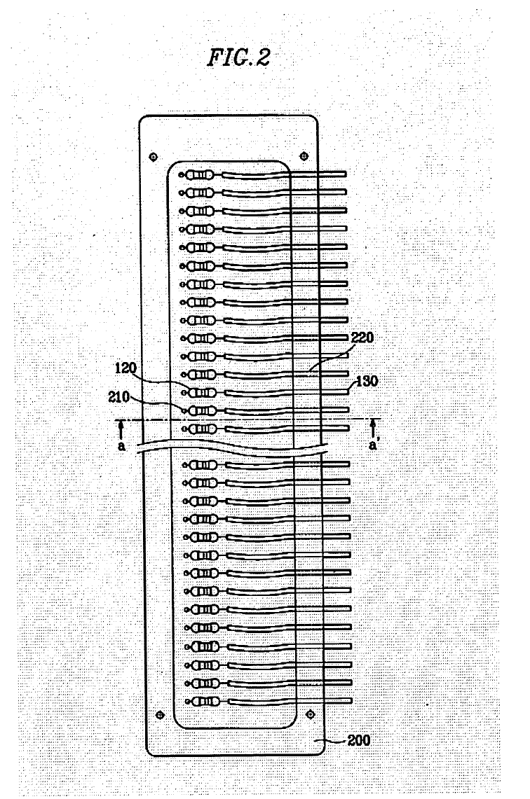

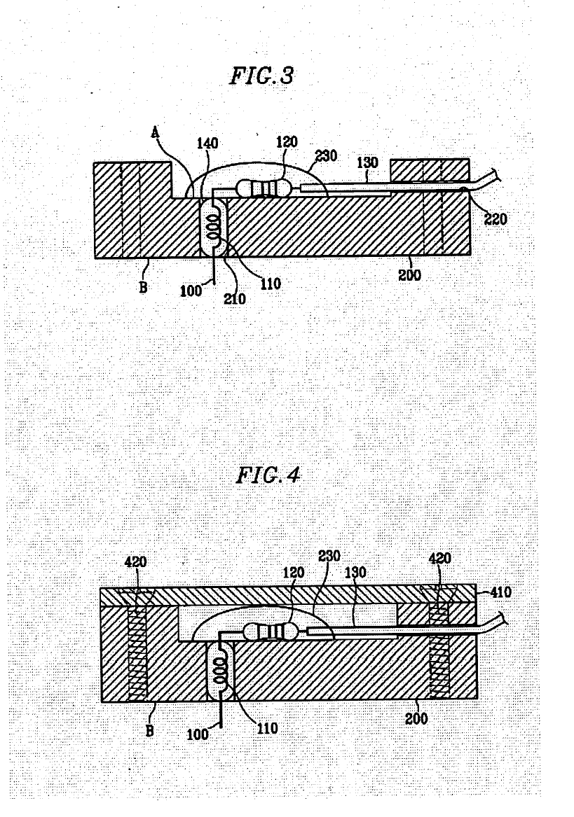

FIG. 2, FIG. 3, and FIG. 4 illustrate a cell voltage detecting assembly utilizing the above-described cell voltage detecting unit.

As shown in FIG. 2 and FIG. 3, the cell voltage detecting assembly includes a plurality of cell voltage detecting units, and a supporting unit 200 for securing the cell voltage detecting units to the cells.

A plurality of probe holes 210 are formed through the supporting unit 200 for receiving the probes 100 of the cell voltage detecting units. The probe holes 210 are formed between an upper surface “A” and a lower surface “B”, and the diameter of the probe hole 210 equals the diameter of the spring housing 140 such that the spring housing is secured to the probe hole 210 and the probe 100 can maintain contact with the cell 150. Furthermore, a plurality of guide holes 220 are formed through a side wall of the upper surface “A” so as to guide the extend cables 130.

The upper surface “A” of the supporting unit 200 is covered with silicon resin 230 such that conjunctions between the springs 110 and the resistors 120 and conjunctions between the resistors 120 and the extend cables 130 are insulated and secured to the upper surface “A”.

As shown in FIG. 4, the supporting unit 200 is covered with a cover plate 410 such that durability of the cell voltage detecting assembly is improved. Preferably, the cover plate 410 is connected to the supporting unit 200 with a plurality of bolts 420.

According to the cell voltage detecting unit and assembly, the probe is connected to the cell with security. Furthermore, the voltage of a plurality of cells can be easily detected by the cell voltage detecting assembly without short circuits.

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

What is claimed is:

1. A cell voltage detecting unit interconnecting a cell and an SVM, comprising:
a probe having contact with the cell for detecting the cell voltage;
an elastic means connected to the probe for absorbing impact;
a resistor connected to the elastic means opposite to the probe; and
an extend cable for connecting the resistor to the SVM.

2. The cell voltage detecting unit of claim 1, wherein the elastic means is a spring.

3. The cell voltage detecting unit of claim 2, further comprising a spring housing formed around the spring.

4. The cell voltage detecting unit of claim 3, wherein the spring housing is formed of epoxy resin.

5. A cell voltage detecting assembly interconnecting a cell and an SVM, comprising:
a plurality of cell voltage detecting units; and
a supporting unit for securing the plurality of cell voltage detecting units to the cells,
wherein the cell voltage detecting unit includes a probe, an elastic means connected to the probe for absorbing impact, a resistor connected to the elastic means, an extend cable for connecting the resistor to the SVM, and a housing formed around the elastic means,
wherein a plurality of probe holes are formed through the supporting unit for respectively receiving the housings formed around the elastic means, and
wherein a plurality of guide holes are formed on a side wall of the supporting unit for respectively guiding the extend cables to the SVM.

6. The cell voltage detecting assembly of claim 5, wherein the elastic means is a spring.

7. The cell voltage detecting assembly of claim 6, wherein a surface of the supporting unit opposite to the cells is covered with silicon resin for insulation.

8. The cell voltage detecting assembly of claim 7, further comprising a cover plate for covering the supporting unit.
